(19) United States
(12) Patent Application Publication
(10) Pub. No.: US 2023/0234654 A1
(43) Pub. Date: Jul. 27, 2023

(54) VACUUM SUCTION WALL-CLIMBING ROBOT

(71) Applicant: Industrial Technology Research Institute, Hsinchu (TW)

(72) Inventors: Chao-Jen LI, Hsinchu City (TW); Sheng-Wen YEH, Taichung City (TW); Han-Kuei FU, New Taipei City (TW); Chin-Pang TU, Taichung City (TW); Shi-Dian LUO, Hsinchu County (TW)

(21) Appl. No.: 17/743,339

(22) Filed: May 12, 2022

(30) Foreign Application Priority Data
Jan. 27, 2022 (TW) 111103528

(51) Int. Cl. B62D 57/024; B62D 57/032

(52) U.S. Cl. CPC B62D 57/024; B62D 57/032

(57) ABSTRACT

A vacuum suction wall-climbing robot including a body, a vacuum pump and at least four leg mechanisms is disclosed. Each leg mechanism includes a foot unit and a limb unit connecting the foot unit and the body. The foot unit includes a plurality of suction sets connected to the vacuum pump through a pipe. Each suction set includes a sucker able to create a vacuum state within a contact area through the operation of the vacuum pump, and a sheet valve arranged between the pipe and the sucker, which automatically closes the connection between the pipe and the sucker when the vacuum state between the sucker and the contact area becomes a non-vacuum state.

### CROSS REFERENCE TO RELATED APPLICATIONS

This Application claims priority of Taiwan Patent Application No. 111103528, filed on Jan. 27, 2022, the entirety of which is incorporated by reference herein.

### TECHNICAL FIELD

The technical field relates to a vacuum suction wall-climbing robot.

### BACKGROUND

Power plants require periodical safety inspections to prevent accidents and maintain public safety. However, due to the large size of power plants and the need for work in safety inspections to be carried out aloft, the cost of inspection and steel frame building/scaffold and the risk of accidents are high when this operation is performed manually. Thus, there is a need for a wall-climbing robot with high reliability and robustness to replace manual operation in the safety inspections of power plants, so as to save inspection time and to avoid the hazards of manually working aloft

### SUMMARY

An embodiment of the present disclosure relates to a vacuum suction wall-climbing robot including a body, a vacuum pump and at least four leg mechanisms. Each leg mechanism includes a foot unit and a limb unit connecting the foot unit and the body. The foot unit includes a plurality of suction sets connected to the vacuum pump through a pipe. Each suction set includes a sucker able to create a vacuum state within a contact area by the operation of the vacuum pump, and a sheet valve arranged between the pipe and the sucker, which automatically closes the connection between the pipe and the sucker when the vacuum state between the sucker and the contact area becomes a non-vacuum state.

### BRIEF DESCRIPTION OF THE DRAWINGS

The present disclosure can be more fully understood by reading the subsequent detailed description and examples with references made to the accompanying drawings, wherein:

FIGS. 1A and 1B show an exemplary embodiment of the present disclosure;

FIG. 2 shows a schematic diagram of an exemplary suction structure according to the present disclosure;

FIGS. 3A, 3B and 3C show an exemplary suction set linkage mechanism according to the present disclosure;

FIGS. 4A and 4B shows an embodiment of an internal control system of a six-legged robot according to the present disclosure;

FIG. 5 shows an embodiment of the walking gait of the six-legged robot according to the present disclosure; and

FIG. 6 shows an embodiment of the obstacle-crossing gait of the six-legged robot according to the present disclosure.

The present disclosure is susceptible to various modifications and alternative forms, and some representative embodiments have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of the disclosure as defined by the appended claims.

### DETAILED DESCRIPTION

The present disclosure describes various examples or embodiments for implementing different features of the subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

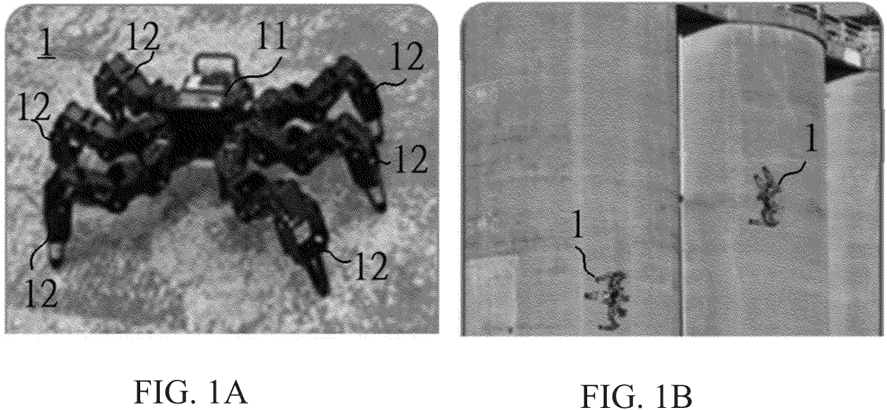

FIGS. 1A and 1B show an exemplary embodiment of the present disclosure. As shown in FIG. 1A, an implementation of the present disclosure is a six-legged robot 1 including a body 11 and a plurality of (e.g. six) leg mechanisms 12, the six-legged robot 1 is able to climb the wall (e.g. a cement wall) of a power plant to perform the safety inspection of the power plant, as shown in FIG. 1B. The exemplary robot described in the present disclosure is six-legged, but the application of the present disclosure is not limited thereof and may apply to any robot including four or more legs. Additionally, the application of the present disclosure may apply to any robot including four or more legs symmetrically arranged at both sides of the body of the robot.

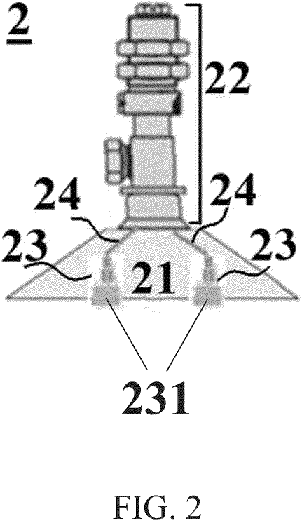

To climb the vertical wall, each leg mechanism of the six-legged robot requires a suction structure. FIG. 2 shows a schematic diagram of a non-limiting exemplary suction structure. In FIG. 2, a leg mechanism 2 (e.g. the leg mechanism 12 shown in FIG. 1A) has/includes a foot unit 21 and a limb unit 22. The limb unit 22 may include a joint to allow bending and extending of the limb unit 22. The limb unit 22 connects the foot unit 21 and the body of the robot (not shown in the figure). The foot unit 21 includes a plurality of suction sets 23, where each suction set 23 is connected to a vacuum pump (not shown in the figure) through a pipe 24, so as to generate a vacuum state to attach to the wall. The suction set 23 may include multiple materials, such as (but not limited to) a rubber layer 231 covering a metal layer, the metal layer prevents the deformation of the sucker that breaks the vacuum state.

In practice, the wall of the power plant may have obstacles that may accidentally break the vacuum state of the suction sets and cause the six-legged robot fall from the wall. To prevent such cases, there is a need to prevent the accidental break of a single suction set from causing the entire leg lose the attachment to the wall. Thus, each foot unit 21 includes a plurality of suction sets 23, and these suction sets 23 have a linkage mechanism. When one of the suction sets loses the vacuum state, the vacuum state of the other suction sets is protected immediately to prevent the entire foot unit 21 from losing the attachment to the wall.

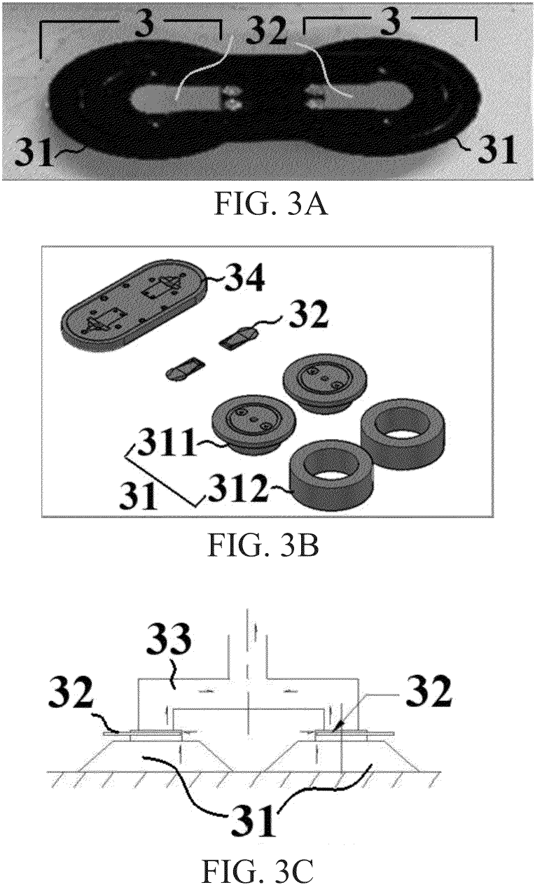

FIGS. 3A, 3B and 3C show an exemplary suction set linkage mechanism. As shown in FIGS. 3A, 3B and 3C, each of two suction sets 3 (corresponding to the suction set 23 shown in FIG. 2) have a sucker 31 and a sheet valve 32, and the two suction sets 3 are linked to a vacuum pump (not shown in the figures) through an interconnected pipe 33. Referring to FIG. 3B, the sucker 31 includes a metal part 311 and rubber part 312, the rubber part 312 corresponding to the rubber layer 231. The metal part 311 is covered by the rubber part 312 to prevent the deformation of the sucker that breaks the vacuum state. A common fixing bracket 34 connects each sheet valve 32 and sucker 31 within the same suction set 3. Referring to FIG. 3C, when the vacuum pump is operating, the enclosed space formed within the contact area between the rubber part 312 and the wall is set into a vacuum state. When the vacuum state of any sucker 31 is broken accidentally and becomes a non-vacuum state due to reasons such as an accidental malfunction of the vacuum pump or the obstacles and/or roughness on the wall, the air pressure within the sucker 31 is approximately 1 atm while the air pressure within the pipe 33 is lower than 1 atm due to the persistent operation of the vacuum pump (not shown in the figures). Thus, due to the air pressure within the sucker 31 being greater than the air pressure within the pipe 33, the sheet valve 32 corresponding to the sucker 31 automatically closes upwards and adheres to the common fixing bracket 34 due to the pressure difference, which blocks/ closes/ turns off the connection between the contact area and the pipe 33, so as to prevent the non-vacuum state of the sucker 31 from affecting the vacuum state of the other sucker 31, protecting the attachment to the wall of the entire foot. Herein, the sheet valve 32 is, for example, a sheet valve having an elastic metal sheet, which is fixed at one end and floating at the other end. The elastic metal sheet is fixed on, for example, the fixing bracket 34. The fixing bracket 34 is, for example, a metal bracket.

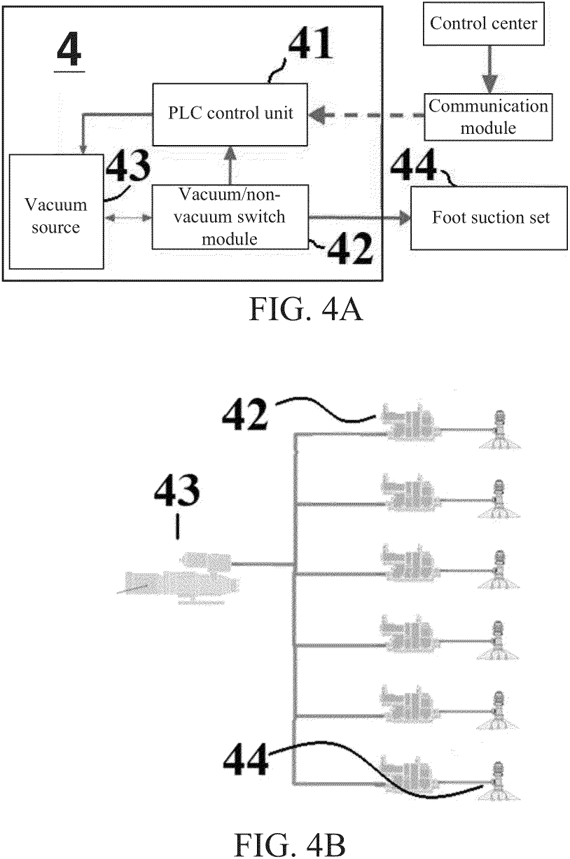

To further prevent the obstacles on the wall from hindering the six-legged robot performing its operations, there is a further need of designing an obstacle-crossing gait and allowing the six-legged robot effectively switch between the normal walking gait and the obstacle-crossing gait, so as to allow the six-legged robot use the walking gait when no obstacle is detected and use the obstacle-crossing gait when an obstacle is detected, so that the possible disadvantageous environment in practical applications may be overcome and the availability of the six-legged robot may be increased. FIGS. 4A and 4B show an embodiment of the internal control system of a six-legged robot. Referring to FIG. 4A, a six-legged robot (e.g. the six-legged robot 1 shown in FIG. 1A) has a robot module 4, arranged on, for example, the body 11. The robot module 4 includes a programmable logic controller (PLC) module 41, a vacuum/non-vacuum switch module 42 and a vacuum source 43. A control center located external to the robot module 4 is communicable with the PLC module 41 through a communication module to further monitor and adjust the performance of the six-legged robot. The PLC module 41 controls the six-legged robot to perform the walking gait or the obstacle-crossing gait. The vacuum/non-vacuum switch module 42 receives a non-vacuum command/ break vacuum command and a vacuum command sent from the PLC module 41 to control the foot suction set 44 into a non-vacuum state and a vacuum state respectively. Referring to FIG. 4B, based on the required gait, the PLC module 41 sends a non-vacuum command and/or a vacuum command to the vacuum/non-vacuum switch module 42 of each foot. The vacuum source 43 (e.g. a micro vacuum pump) persistently sucks air. The vacuum/non-vacuum switch module 42 (e.g. an electromagnetic valve) switches the non-vacuum state and the vacuum state of the foot suction set 44 based on the non-vacuum command and the vacuum command sent from the PLC module, so as to allow the six-legged robot perform the walking gait or the obstacle-crossing gait.

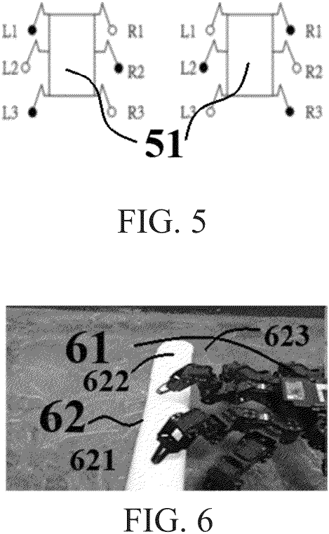

FIG. 5 shows an embodiment of the walking gait of a six-legged robot 51 (e.g. the six-legged robot 1 shown in FIG. 1A). Each two leg mechanisms of the six-legged robot 51 are vertically symmetric / left-right symmetric and located at both sides of the front, the middle and the back of the body of the robot respectively. The left front leg L1, the right middle leg R2 and the left back leg L3 form a first leg set, while the right front leg R1, the left middle leg L2 and the right back leg R3 form a second leg set. When the six-legged robot is performing the walking gait, the first leg set and the second leg set take turns to perform the operations of raising legs, turning legs and lowering legs. When performing the operation of raising legs, the PLC module sends a non-vacuum command/ break vacuum command, and the legs raise; when performing the operation of lowering legs, the PLC module sends a vacuum command, and the legs are lowered and attached to the wall. The operations are performed repeatedly to achieve the walking gait of the six-legged robot 51.

FIG. 6 shows an embodiment of the obstacle-crossing gait of a six-legged robot 61 (e.g. the six-legged robot 51 shown in FIG. 5). The body (e.g. the upper part of the body) of the six-legged robot 61 is equipped with a sensor. When the sensor detects an obstacle 62 on the walking direction of the six-legged robot 61, the PLC module changes to the obstacle-crossing gait and sends the non-vacuum command and the vacuum command to the six legs sequentially. An example of an effective obstacle-crossing gait is pairing the legs and crossing the obstacle 62 sequentially, where the left front leg L1 and the right front leg R1 form a first leg set, the left middle leg L2 and the right middle leg R2 form a second leg set, and the left back leg L3 and the right back leg R3 form a third leg set. When the six-legged robot 61 is performing the obstacle-crossing gait, the following operations are executed:
Operation 1a: the PLC module sends the non-vacuum commands of the left front leg L1 and the right front leg R1 sequentially to detach the foot units of the left front leg L1 and the right front leg R1 from the wall;
Operation 1b: the leg mechanisms of the left front leg L1 and the right front leg R1 raise, cross the obstacle 62 and lower down;
Operation 1c: the PLC module sends the vacuum commands of the left front leg L1 and the right front leg R1 sequentially to re-attach the foot units of the left front leg L1 and the right front leg R1 on a surface 621 of the wall in the front of the obstacle 62;
Operation 2a: the PLC module sends the non-vacuum commands of the left middle leg L2 and the right middle leg R2 sequentially to detach the foot units of the left middle leg L2 and the right middle leg R2 from the wall;
Operation 2b: the leg mechanisms of the left middle leg L2 and the right middle leg R2 raise, and the foot units of the left middle leg L2 and the right middle leg R2 touch a top surface 622 of the obstacle 62;
Operation 2c: the PLC module sends the vacuum commands of the left middle leg L2 and the right middle leg R2 sequentially to attach the foot units of the left middle leg L2 and the right middle leg R2 on the top surface 622 of the obstacle 62;
Operation 2d: the PLC module sends the non-vacuum commands of the left back leg L3 and the right back leg R3 sequentially to detach the foot units of the left back leg L3 and the right back leg R3 from the wall;
Operation 2e: the leg mechanisms of the left back leg L3 and the right back leg R3 raise and move forward without crossing or touching the obstacle 62, and then lower down;
Operation 2f: the PLC module sends the vacuum commands of the left back leg L3 and the right back leg R3 sequentially to re-attach the foot units of the left back leg L3 and the right back leg R3 on a surface 623 of the wall at the rear of the obstacle 62;
Operation 2g: the PLC module sends the non-vacuum commands of the left middle leg L2 and the right middle leg R2 sequentially to detach the foot units of the left middle leg L2 and the right middle leg R2 from the top surface 622 of the obstacle 62;
Operation 2h: the leg mechanisms of the left middle leg L2 and the right middle leg R2 raise and move the foot units of the left middle leg L2 and the right middle leg R2 forward to the surface 621 of the wall in the front of the obstacle 62;
Operation 2i: the PLC module sends the vacuum commands of the left middle leg L2 and the right middle leg R2 sequentially to re-attach the foot units of the left middle leg L2 and the right middle leg R2 on a surface 621 of the wall in the front of the obstacle 62;
Operation 3a: the PLC module sends the non-vacuum commands of the left back leg L3 and the right back leg R3 sequentially to detach the foot units of the left back leg L3 and the right back leg R3 from the wall;
Operation 3b: the leg mechanisms of the left back leg L3 and the right back leg R3 raise, and the foot units of the left back leg L3 and the right back leg R3 touch the top surface 622 of the obstacle 62;
Operation 3c: he PLC module sends the vacuum commands of the left back leg L3 and the right back leg R3 sequentially to attach the foot units of the left back leg L3 and the right back leg R3 on the top surface 622 of the obstacle 62;
Operation 3d: the PLC module sends the non-vacuum commands of the left back leg L3 and the right back leg R3 sequentially to detach the foot units of the left back leg L3 and the right back leg R3 from the top surface 622 of the obstacle 62;
Operation 3e: the leg mechanisms of the left back leg L3 and the right back leg R3 raise and move the foot units of the left back leg L3 and the right back leg R3 forward to the surface 621 of the wall in the front of the obstacle 62;
Operation 3f: the PLC module sends the vacuum commands of the left back leg L3 and the right back leg R3 sequentially to re-attach the foot units of the left back leg L3 and the right back leg R3 on a surface 621 of the wall in the front of the obstacle 62.

Additionally, in cases where the leg mechanisms of the left front leg L1 and the right front leg R1 are unable to cross the obstacle 62 with a single movement, the PLC module may successively send multiple non-vacuum commands and vacuum commands to make the leg mechanisms L1-R1, L2-R2 and L3-R3 sequentially move and attach to the obstacle 62, so as to cross over or climb onto the obstacle 62. Further, the moving and attaching sequence of the leg mechanisms L1-R1, L2-R2 and L3-R3 may be adaptively altered to overcome various types of possible obstacles.

The foregoing description of the embodiments, including illustrated embodiments, has been presented for the purpose of illustration and description and is not intended to be exhaustive or limiting to the precise forms disclosed. Numerous modifications, adaptations, and uses thereof will be apparent to those skilled in the art. Numerous changes to the disclosed embodiments can be made in accordance with the disclosure herein, without departing from the spirit or scope of the disclosure. Thus, the breadth and scope of the present disclosure should not be limited by any of the above described embodiments.

Although certain embodiments and features of the present disclosure have been illustrated and described with respect to one or more implementations, equivalent alterations and modifications will occur or be known to others skilled in the art upon the reading and understanding of this specification and the annexed drawings. In addition, while a particular feature of the disclosure may have been disclosed with respect to one of several implementations, such feature may be combined with one or more other features of the other implementations as may be desired and advantageous for any given or particular application.

The terminology used herein is for the purpose of describing particular embodiments, and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

What is claimed is:

1. A vacuum suction wall-climbing robot, comprising:
a body;
a vacuum pump; and
at least four leg mechanisms;
wherein each of the leg mechanisms comprises a foot unit and a limb unit connecting the foot unit and the body;
wherein the foot unit comprises a plurality of suction sets connected to the vacuum pump through a pipe;
wherein each of the suction sets comprises:
a sucker, the sucker being able to create a vacuum state within a contact area through the operation of the vacuum pump; and
a sheet valve arranged between the pipe and the sucker, wherein the sheet valve automatically closes the connection between the pipe and the sucker when the vacuum state between the sucker and the contact area becomes a non-vacuum state.

2. The vacuum suction wall-climbing robot as claimed in claim 1, wherein:
the sucker comprises a fixing bracket;
the sheet valve is arranged on the fixing bracket;
an end of the sheet valve is fixed, and the other end of the sheet valve is floating; and
the sheet valve operates based on a pressure difference between the sucker and the pipe.

3. The vacuum suction wall-climbing robot as claimed in claim 1, further comprising:
a programmable logic controller (PLC) module configured to control the vacuum suction wall-climbing robot to perform a walking gait or an obstacle-crossing gait;
a vacuum/non-vacuum switch module configured to receive a non-vacuum command and a vacuum command sent from the PLC module, so as to control the sucker to the non-vacuum state and the vacuum state respectively.

4. The vacuum suction wall-climbing robot as claimed in claim 3, further comprising a sensor for detecting obstacles;
wherein the at least four leg mechanisms include six leg mechanisms, each two of the leg mechanisms are vertically symmetrically arranged at both sides of the front, the middle and the back of the body; and
wherein the both sides of the front of the body includes a left front leg and a right front leg, the both sides of the middle of the body includes a left middle leg and a right middle leg, and the both sides of the back of the body includes a left back leg and a right back leg.

5. The vacuum suction wall-climbing robot as claimed in claim 4, wherein:
the left front leg, the right middle leg and the left back leg form a first leg set, and the right front leg, the left middle leg and the right back leg form a second leg set;
when the vacuum suction wall-climbing robot is performing the walking gait, the first leg set and the second leg set take turns to perform the operations of raising legs, turning legs and lowering legs.

6. The vacuum suction wall-climbing robot as claimed in claim 4, wherein when the sensor detects an obstacle, the PLC module controls the vacuum suction wall-climbing robot to perform the obstacle-crossing gait.

7. The vacuum suction wall-climbing robot as claimed in claim 6, wherein when the vacuum suction wall-climbing robot is performing the obstacle-crossing gait, the PLC module successively send a plurality of non-vacuum commands and vacuum commands, so as to make the leg mechanisms at the both sides of the front, the middle and the back of the body move and attach sequentially.

8. The vacuum suction wall-climbing robot as claimed in claim 7, wherein when the vacuum suction wall-climbing robot is performing the obstacle-crossing gait, the left front leg and the right front leg move simultaneously, the left middle leg and the right middle leg move simultaneously, and the left back leg and the right back leg move simultaneously.
